(19) United States
(12) Patent Application Publication
(10) Pub. No.: US 2005/0153758 A1
(43) Pub. Date: Jul. 14, 2005

(54) Apparatus, system and method of integrating wireless telephones in vehicles

(75) Inventors: Scott J. Broussard, Cedar Park, TX (US); Ying Liu, Austin, TX (US); Ann M. Robinson, Round Rock, TX (US); Eduardo N. Spring, Round Rock, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/756,131

(22) Filed: Jan. 13, 2004

(51) Int. Cl. H04Q 7/20

(52) U.S. Cl. 455/575.9

(57) ABSTRACT

A system, apparatus and method of integrating a wireless telephone in a vehicle are provided. The system, apparatus and method consist of installing a parabolic speaker in the vehicle that has a focused listening area at a location where an operator of the vehicle may be situated. The parabolic speaker may further have an integrated microphone. When a wireless telephone is placed in a cradle, that may be available in the vehicle for receiving the telephone, the telephone will be integrated in the vehicle. Consequently, the telephone will interact with the vehicle's on-board computer (OBC). The OBC may then route all in-coming signals from the wireless telephone to the parabolic speaker. Further, the OBC may route all out-going signals from the integrated microphone to the wireless telephone.

### BACKGROUND OF THE INVENTION

1. Technical Field

The present invention is directed to wireless telephones. More specifically, the present invention is directed to an apparatus, system and method of integrating wireless telephones in vehicles.

2. Description of Related Art

Since the introduction of cellular telephones in 1983, there have been dramatic changes in the wireless telephone industry. For example, cellular telephones have gone from heavy, cumbersome and expensive telephones to inexpensive, miniature hand held units. These changes have had a significant impact on when, where and how we conduct our affairs, both business and personal. Further, societal pressures for increased efficiency, more leisure time, and an improved sense of safety, have made the use of a cellular telephone ideal for an increasingly mobile and technologically sophisticated population. Consequently, it is not at all surprising that there has been an increase in the use of wireless telephones in moving vehicles.

However, this increase has been accompanied by growing concern for potential hazards. Research studies have shown that the use of cellular telephones while driving can increase the risk of vehicle crashes. To reduce this risk, the wireless industry, as well as the automobile industry, has been integrating, through various methods, wireless telephones in vehicles.

The present invention provides a novel method of integrating wireless telephones in vehicles.

### SUMMARY OF THE INVENTION

The present invention provides system, apparatus and method of integrating a wireless telephone in a vehicle. The system, apparatus and method consist of installing a parabolic speaker in the vehicle that has a focused listening area at a location where an operator of the vehicle may be situated. The parabolic speaker may further have an integrated microphone. When a wireless telephone is placed in a cradle, that may be available in the vehicle for receiving the telephone, the telephone will be integrated in the vehicle. Consequently, the telephone will interact with the vehicle's on-board computer (OBC). The OBC may then route all in-coming signals from the wireless telephone to the parabolic speaker. Further, the OBC may route all out-going signals from the integrated microphone to the wireless telephone.

Further, as the parabolic speaker with integrated microphone is connected to the OBC, the operator of the vehicle may also access available features of the vehicle through voice commands that may be received by the integrated microphone.

In a particular embodiment, a plurality of microphones may be installed in the cabin of the vehicle. The microphones may be used to allow any occupant of the vehicle to access available features of the vehicle. In the case where certain features of the vehicle should not be accessed by any occupants other the operator, before a command is executed, the OBC may determine the location or position of the occupant issuing the command. If the occupant is not the operator and therefore should not have access to the features, the command may be ignored or an error message may be generated.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a schematic block diagram of a telephone apparatus.

FIG. 2 depicts an exemplary operating panel of the telephone.

FIG. 3 depicts a schematic block diagram of an on-board computer (OBC) of a vehicle.

FIG. 4 depicts a parabolic speaker that may be used by the present invention.

FIG. 5 depicts a top view of a speaker with integrated microphone used by the parabolic speaker.

FIG. 6 depicts the sound beams used by the integrated microphone.

FIG. 7 depicts a plurality of microphones used for sound triangulation.

FIG. 8 is a flow chart of a process that may be used to access the features of the telephone and/or the vehicle.

FIG. 9 is a flowchart of a process that may be used to access the vehicle's features by occupants.

### DETAILED DESCRIPTION OF THE PREFERRED EMBODIMENT

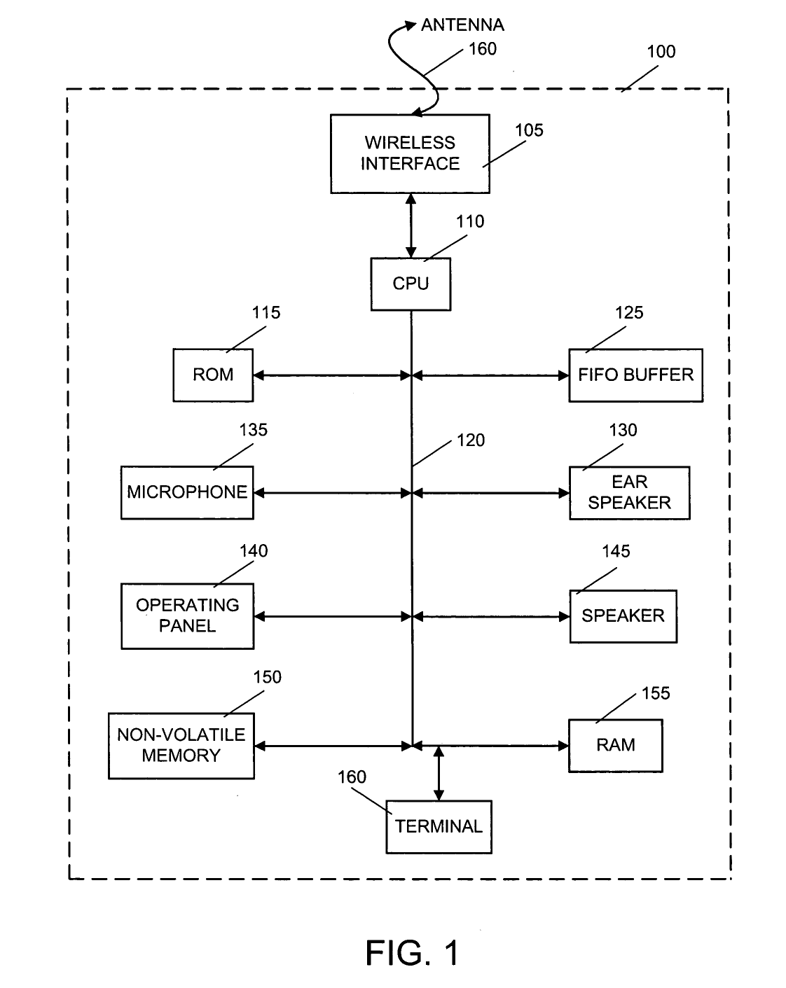

Turning to the figures, FIG. 1 depicts a schematic block diagram of a wireless telephone apparatus 100. The wireless telephone apparatus 100 is connected to an antenna 160 through a wireless interface 105. The antenna 160 may be a wireless vehicle antenna for those telephones that are integrated in a vehicle or the antenna of the telephone itself otherwise. The antenna 105 is connected to CPU 110. CPU 110 is connected to ROM 115, first-in, first-out (FIFO) buffer 125, ear speaker 145, speaker 130, microphone 135, operating panel 140, non-volatile memory 150, RAM 155 and terminal 160 via a bus 120.

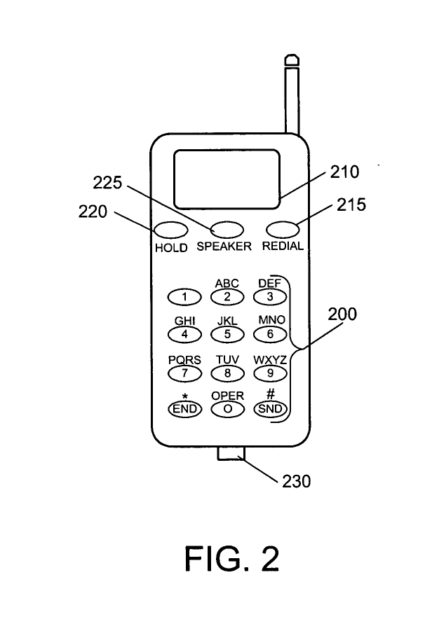

With the use of a software utility package stored in ROM 115, CPU 110 performs various functions. For example, the CPU 110 may send a ring tone to ear speaker 130 whenever the antenna interface 105 detects a ring signal. Likewise, CPU 110 may send a busy tone signal to ear speaker 130 when the antenna interface 105 detects a busy signal. Furthermore, when a dial tone is detected, CPU 110 may send the dial tone to ear speaker 130. If the CPU 110 detects that a speaker phone button (see FIG. 2) has been depressed, it may send the aforementioned tones to speaker 145 instead of to ear speaker 130. Microphone 135 allows for communication without holding the telephone to one's ear. Non-volatile memory 150 is used to store a phone book and FIFO buffer 125 is used to store the most recently dialed number for the redial feature.

FIG. 2 depicts operating panel 140. The operating panel 140 contains an LCD (Liquid Crystal Display) screen 210 and a dial pad 200. The LCD screen 210 may be used to display a telephone number that is being dialed or has been dialed as well as to display the telephone number of an incoming call. Dial pad 200 may be used for dialing numbers. Hold button 220 may be used for putting a person with whom the user is communicating on hold. Redial button 220 may be used a previously dialed number and speaker phone button 225 allows for one to communicate without holding the telephone to one's ear. Send button 230 allows a user to actually place a call and interface 235 facilitates integration of the telephone in a vehicle.

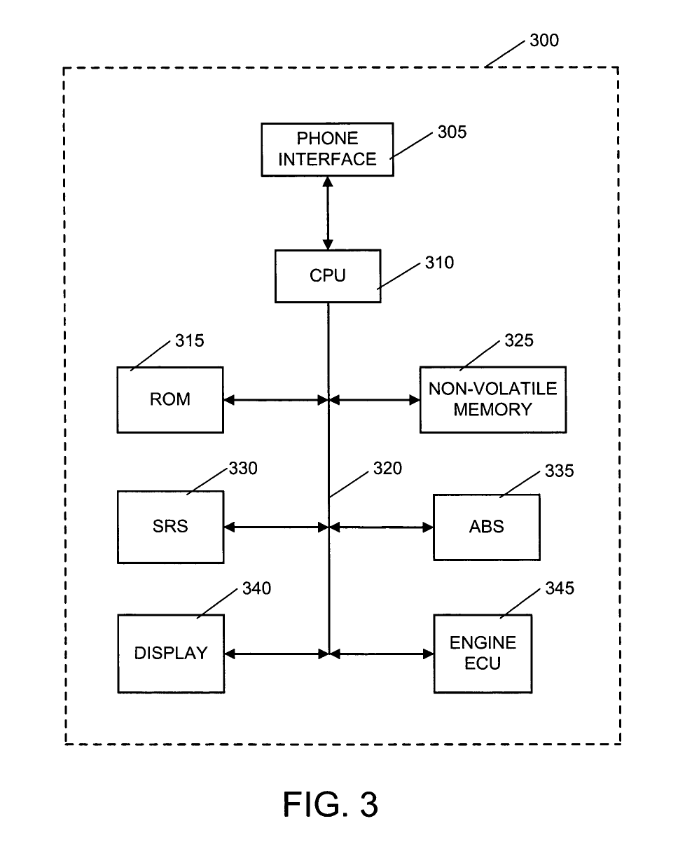

Particularly, modern vehicles are typically equipped with an on-board computer (OBC). The OBC is used to perform diagnostic functions as well as to control the vehicles. FIG. 3 depicts a schematic block diagram of an exemplary OBC 300 of a vehicle. The OBC 300 includes a CPU 310 that is connected to a non-volatile memory 325, an anti-lock braking system (ABS) 335, an engine electronic control unit (ECU) 345, ROM 315, supplemental restraint system (SRS) 330 and dash display 340 through bus 320.

The non-volatile memory 325 may be used to store data such as odometer readings, total mileage of the vehicle, the vehicle identification number (VIN), etc. The ROM 315 may be used to store a software package that controls the CPU 310. For example, the CPU 310, under the control of the software package, may display battery voltage, speedometer readings, turn on and/or off all dash display lights etc.

The ABS 335 may have its own co-processor or use the CPU 310. In either case, when a driver applies the brake in a panic, the ABS 335 may modulate the breaking force that is actually applied to the wheels. Furthermore, if a wheel is slipping, the ABS 335 may slow the wheel down and/or shift the driving force to a non-slipping wheel etc.

The engine ECU 345 controls the engine, self-diagnoses abnormalities relating to the exhaust emission of the engine and transmits the information to the CPU 310 for storage into the non-volatile memory 325 and/or for display on display 340. For example, a problem with the engine may turn on a “check engine” light on the dashboard. The problem may be stored in memory to be read out by a mechanic.

The SRS 330 includes front airbags, side impact airbags, rear airbags, safety belts etc. Some modern vehicles have sensors to determine where occupants are seated, the weight of the occupants as well as whether seat belts are fastened. With this information, SRS 330 determines whether any one of the airbags is to be deployed and at what force etc. in case of an accident.

The CPU 310 may also be connected to a telephone interface 305. Thus, when the wireless telephone 100 is integrated in a vehicle, all its functions may be accessed through the OBC 300. In that case, the OBC 300 may communicate with CPU 110 through interface 315. Note that a vehicle may be an automobile, boat, plane etc. Further, note that the vehicle may have a receptacle or cradle that facilitates the vehicle's OBC to communicate with CPU 110. In any case, when the telephone is integrated in a vehicle, ear speaker 130, speaker 145 and microphone 135 may be disabled. A speaker and microphone from the vehicle may then be used.

According to the invention, the vehicle speaker may preferably be a sound localization speaker. A sound localization speaker projects a beam of directional sound waves onto a small area, a listening area. When a sound is localized, it is severely attenuated or almost inaudible in any other area but the localized area. Parabolic speakers provide such sound localization.

Parabolic speakers are disclosed in ACOUSTIC IMAGING SOUND DOME by Brown, U.S. Pat. No. 5,532,438, the disclosure of which is herein incorporated by reference. Nonetheless, for a better understanding of the present invention a parabolic speaker will briefly be explained.

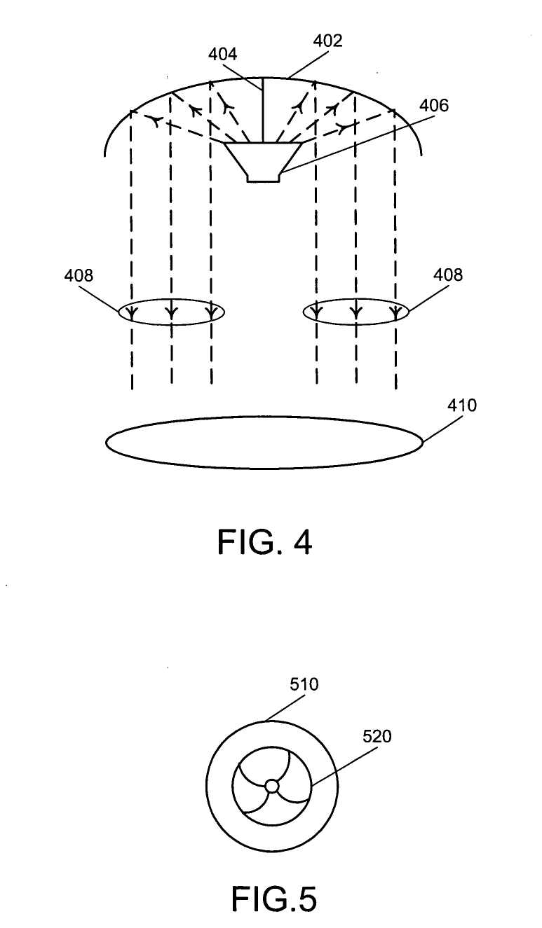

FIG. 4 depicts an exemplary parabolic speaker. The parabolic speaker includes a parabolic reflector 402, a speaker 406 and a speaker rod 404. The length of the rod 402 is equal to the focal length of the parabolic speaker (i.e., the speaker 402 is located at the focal point of the parabolic reflector). This length is preferably short thereby allowing for a rather flat parabolic reflector.

The speaker 406 faces the parabolic reflector 402 such that sound from the speaker is reflected off the reflector 402 in the pattern shown by sound beams 408. Thus, the sound is focused on listening area 410. Consequently, if the parabolic speaker were to be mounted in the roof of an automobile above a driver (i.e., the driver is located in area 410), then only the driver would be able to effectively hear sound emitted from the speaker 406.

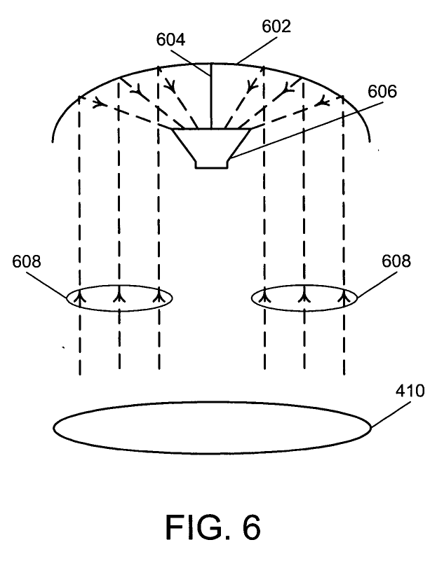

Further, the speaker 406 may include an integrated microphone. The microphone is shown in FIG. 5. Specifically, the microphone includes the area between outer circle 510 and inner circle 520 whereas the speaker encompasses the area within inner circle 520. As shown in FIG. 6, the microphone, which is integrated in speaker 606 may pick up sound, shown as beams 608 emitted from within listening area 610. The beams 608 will bounce off the reflector 602 into the integrated microphone. Thus, to continue with the example above, if the parabolic speaker with integrated microphone is mounted in the roof of the car above the driver, then the voice of the driver may be picked up by the microphone.

There may be instances where the microphone may pick up stray sounds from other occupants of a vehicle. However, since these occupants are not in listening area 610, the stray sounds may not be of a high enough amplitude as those coming from the driver. Hence, they may be easily filtered out. For example, a minimum amplitude threshold may be set such that any sound with an amplitude less than the threshold may be filtered out of the system. In addition, any ambient noise from the vehicle may also be filtered out.

Thus, to access the features of the wireless telephone, the integrated microphone may be used to control features available in the vehicle via voice recognition. In this case, all the features that are only available to an operator of the vehicle can be accessed using the integrated microphone if the listening area 610 of the parabolic speaker with integrated microphone is at the location where the operator is likely to be situated. These features may include environmental (inside cabin temperature settings) as well as navigational features (i.e., navigation system).

In addition, a dedicated parabolic speaker with integrated microphone may be situated above each occupant in the vehicle. Consequently, the occupants may access available features of the vehicle. Since there are features that only an operator of a vehicle should have access to, the location of the parabolic speaker with integrated microphone may be used to distinguish the operator of the vehicle from its occupants.

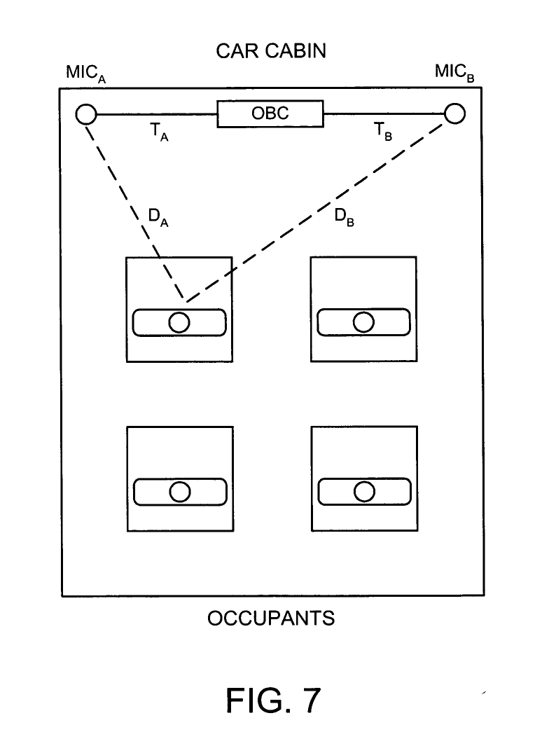

In another embodiment, a stereophonic approach may be used to allow features of a vehicle to be accessed via voice recognition. This approach entails using a minimum of two microphones. The two microphones may be placed in the front cabin of the vehicle or anywhere the voice of the operator and occupants may clearly be captured. The vehicle's OBC may then use sound triangulation to determine the location of any occupant who wants to access the features. For example, in FIG. 7 two microphones, microphones A and B, are placed in the front cabin of a car. The driver of the car is the occupant who is accessing an available feature of the car. Distance d_{A} is the distance of microphone A from the driver, whereas distance d_{B} is the distance of microphone B from the driver. These two distances are different from each other.

Due to the different distances d_{A} and d_{B}, the sound emitted by the driver is received by the OBC, through microphone A and microphone B at different times (t_{A} and t_{B}) . Using this time difference, (which may be calculated by the OBC), the OBC may, based on approximate dimensions of the car cabin, calculate the approximate seating location of the originator of the sound (i.e., the offsets of the signals (in time) indicate different seating positions). Thus, sounds that may come from different seating positions may be filtered out using digital signal filtering to provide data input capability to only one specific occupant, the occupant who activates the system. In this case, the voice of the driver may be isolated. The isolated voice of the driver may be used for command and control through voice recognition to access features of the car or for communications. Additionally, the authority of the speaker may be implied based on seating position.

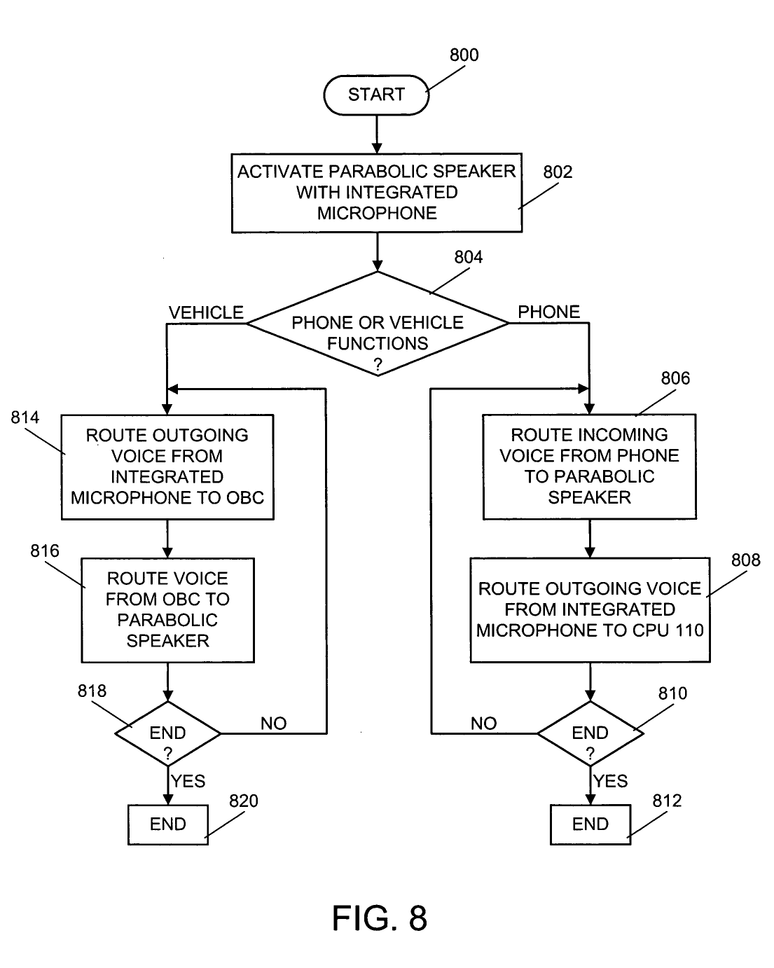

FIG. 8 is a flow chart of a process that may be used to access the features of the telephone and/or the vehicle. The process may be stored in the vehicle's OBC and starts when the wireless telephone is on while in its cradle and receiving an incoming call or the operator is trying to place a telephone call or when the operator presses a button somewhere in the vehicle to access features in the telephone such as pre-stored numbers or features available in the vehicle (step 800). At that point, the parabolic speaker with integrated microphone may be activated (step 802). A check may be made to determine whether the features in the wireless telephone or the available features in the vehicle are being accessed (step 804). If the features in the telephone are being accessed then all incoming voice signals may be routed to the parabolic speaker and all outgoing voice signals may be routed from the integrated speaker to the telephone CPU 110. The process may end when the operator terminates the phone call (steps 806, 808, 810 and 812).

If the features in the vehicle are being accessed, voice signals from the operator may be routed from the integrated microphone to the OBC and synthesized voice that may come from the OBC, if the vehicle is so equipped to do so, may be routed to the parabolic speaker and the process may end (steps 814, 816, 818 and 820).

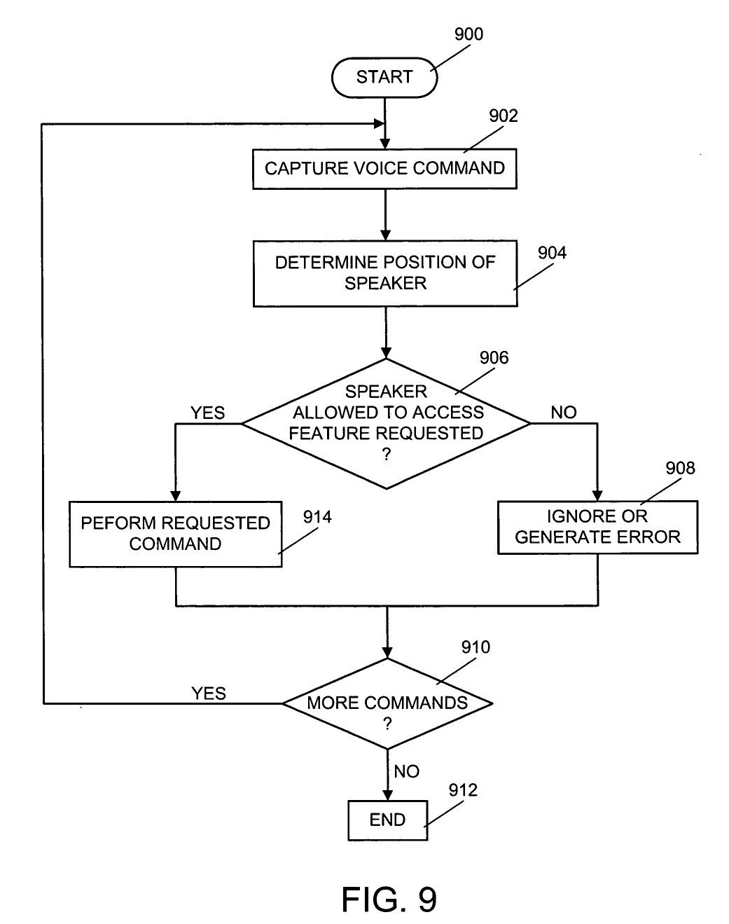

FIG. 9 is a flowchart of a process that may be used to access the vehicle's features by occupants of a vehicle. The process starts when any occupant presses a button that may be close by the occupant or key words, such as the names of the features, are uttered firmly by any occupant. When this occurs the OBC may capture voice commands from the microphones in the vehicle. Upon capturing a voice command, the OBC may determine the location of the occupant who issued the command. Based on the location of the occupant, the OBC may determine whether the occupant has authorization to access the feature. If so, the OBC may execute the command. Otherwise, the command may be ignored or an error message may be generated. The process may end after a certain amount of time has elapsed without receiving a voice command (steps 900-914).

The description of the present invention has been presented for purposes of illustration and description, and is not intended to be exhaustive or limited to the invention in the form disclosed. Many modifications and variations will be apparent to those of ordinary skill in the art. Thus, the embodiment was chosen and described in order to best explain the principles of the invention, the practical application, and to enable others of ordinary skill in the art to understand the invention for various embodiments with various modifications as are suited to the particular use contemplated.

1. A method of integrating a wireless telephone in a vehicle comprising the steps of:
installing a parabolic speaker in the vehicle, the parabolic speaker having a focused listening area at a location where an operator of the vehicle is situated and further having an integrated microphone; and
providing a cradle in the vehicle for integrating the parabolic speaker with an on-board computer (OBC) in the vehicle, the OBC for routing in-coming signals from the wireless telephone to the parabolic speaker and for routing out-going signals from the integrated microphone to the wireless telephone.

2. The method of claim 1 further comprising the step of routing only out-going voice signals from the operator to the wireless telephone by filtering out out-going signals from all other occupants in the vehicle.

3. The method of claim 1 wherein features available in the vehicle are accessed through voice activation from out-going signals from the parabolic speaker when the wireless telephone is off.

4. A computer program product on a computer readable medium for integrating a wireless telephone in a vehicle comprising: code means, when the telephone is placed in a cradle that facilitates integration with an on-board computer (OBC) in the vehicle, for routing in-coming signals from the wireless telephone to a parabolic speaker installed in the vehicle, the parabolic speaker having a focused listening area at a location where an operator of the vehicle is situated and further having an integrated microphone; and
code means for routing out-going signals from the integrated microphone to the wireless telephone.

5. The computer program product of claim 4 further having code means for allowing features available in the vehicle to be accessed through voice activation from out-going signals from the parabolic speaker.

6. An apparatus for integrating a wireless telephone in a vehicle comprising:
means, when the telephone is placed in a cradle that facilitates integration with an on-board computer (OBC) in the vehicle, for routing in-coming signals from the wireless telephone to a parabolic speaker installed in the vehicle, the parabolic speaker having a focused listening area at a location where an operator of the vehicle is situated and further having an integrated microphone; and
means for routing out-going signals from the integrated microphone to the wireless telephone.

7. The apparatus of claim 13 further comprising means for routing only out-going voice signals from the operator to the wireless telephone by filtering out out-going signals from all other occupants in the vehicle.

8. The apparatus of claim 7 wherein only the operator is able to distinctly hear sounds emanating from the parabolic speaker.

9. The apparatus of claim 8 further having means for allowing features available in the vehicle to be accessed through voice activation from out-going signals from the parabolic speaker.

10. The apparatus of claim 9 further having means for allowing the features available in the car to be accessed only when the wireless telephone is off.

11. A system for integrating a wireless telephone in a vehicle comprising:
at least on storage device for storing code data; and
at least one processor for processing the code data to, when the telephone is placed in a cradle that facilitates integration with an on-board computer (OBC) in the vehicle, for route in-coming signals from the wireless telephone to a parabolic speaker installed in the vehicle, the parabolic speaker having a focused listening area at a location where an operator of the vehicle is situated and having an integrated microphone, and to route out-going signals from the integrated microphone to the wireless telephone.

12. The system of claim 11 further processing the code data to route only out-going voice signals from the operator to the wireless telephone by filtering out out-going signals from all other occupants in the vehicle.

13. The system of claim 12 further processing the code data to allow features available in the vehicle to be accessed through voice activation from out-going signals from the parabolic speaker.

14. A method of providing access to available features in a vehicle by occupants comprising the steps of:
installing a plurality of microphones in the vehicle, the microphones connected to an on-board computer (OBC);
determining, when a voice command to access a feature is received from an occupant, whether the occupant is allowed access to the feature; and
executing the command if the occupant is allowed access to the feature.

15. The method of claim 14 wherein the determining step includes the step of determining the position of the occupant in the vehicle using triangulation.

16. A computer program product on a computer readable medium for providing access to available features in a vehicle by occupants comprising:
code means for determining, when a voice command to access a feature is received from an occupant at a plurality of microphones in the vehicle, the microphones connected to an on-board computer (OBC), whether the occupant is allowed access to the feature; and
code means for executing the command if the occupant is allowed access to the feature.

17. An apparatus for providing access to available features in a vehicle by occupants comprising:
means for determining, when a voice command to access a feature is received from an occupant at a plurality of microphones in the vehicle, the microphones connected to an on-board computer (OBC), whether the occupant is allowed access to the feature; and
means for executing the command if the occupant is allowed access to the feature.

18. The apparatus of claim 17 wherein the means for determining whether the occupant is allowed access to the feature includes means for determining the position of the occupant in the vehicle.

19. A system for providing access to available features in a vehicle by occupants comprising:
at least one storage device for storing code data; and
at least on processor for processing the code data to determine, when a voice command to access a feature is received from an occupant at a plurality of microphones in the vehicle, the microphones connected to an on- board computer (OBC), whether the occupant is allowed access to the feature, and to execute the command if the occupant is allowed access to the feature.

20. The system of claim 19 wherein the code data is further processed to determine the position of the occupant in the vehicle.
